(19) United States
(12) Patent Application Publication
(10) Pub. No.: US 2011/0137611 A1
(43) Pub. Date: Jun. 9, 2011

(54) System and Method for Measuring Grain Test Weight On a Dynamic Platform

(76) Inventors: Ronald H. Campbell, Mendon, UT (US); Charles A. Olson, Logan, UT (US); Jule Carl Albretsen, II, Frederictsberg, VA (US); Christopher Alan Hundley, Rochelle, IL (US)

(21) Appl. No.: 12/631,855

(22) Filed: Dec. 6, 2009

(51) Int. Cl. G01G 9/00

(52) U.S. Cl. 702/173

(57) ABSTRACT

Embodiments of the present invention include systems and methods for measuring grain being channeled through a grain harvesting device. The system includes employing a grain test weight measuring apparatus with a weigh bucket for obtaining a test weight measurement of the grain being harvested. The grain test weight measurement apparatus includes a sample cup for weighing grain therein with various sub-assemblies and/or sub-systems to obtain quick and accurate measurements of the grain in-stream on a dynamic platform.

### BACKGROUND OF THE INVENTION

The present invention relates generally to measurement of grain characteristics at harvest time. More specifically, the present invention relates to a system and method for making grain test weight measurements on a moving research harvester.

Grain weight, test weight, and moisture measurements are of importance to farmers and grain harvesters in all regions around the world. These measurements enable determinations to be made and conclusions to be drawn with respect to farming practices and all aspects that affect crop yield. To properly understand and analyze variables that affect grain crop production and seed performance, it is important to acquire grain weight, test weight, and moisture measurements.

Weight, test weight, and moisture measurements of grain are of primary importance to researchers, most notably plant breeders, for the selection and development of grain seeds. Test weight refers to the bulk density of grain, and is typically indicated in the USA with the unit of measure pounds per bushel. This test weight of grain is important because it directly affects the commercial value of the harvested product. For example, the lower the test weight, the lower the value of the grain. Thus, this measurement made on trial grain varieties enables determinations to be made and conclusions to be drawn with respect to which varieties should be included in the various development and seed production programs for the commercial seed trade. Moreover, grain test weight measurements are used by plant breeders to select the most desirable breeding lines for commercial seed.

While engaging in the field test process for developing grain varieties, plant breeders seed a test plot, such as, for example, a five foot wide and twenty foot long area, and seed with a given test variety. In a test field there may exist several hundred plots, with each test variety replicated three or four times, thus allowing statistical analysis of the yield, test weight, and moisture data collected from such a testing process.

With respect to certain grains, such as, for example, corn and wheat, plant breeders must make accurate measurements of test weight (as well as plot weight and moisture content) at harvest time in order to select varieties to commercialize. Plant breeders also use this information to select which seed varieties will be carried forward in breeding program, and which varieties will no longer be tested.

Based on the foregoing, there exists a need to obtain test weight measurements on samples of grain from each test plot, where the test weight measurements are performed quickly and done in the harvest stream of grain from each plot.

### BRIEF SUMMARY OF THE INVENTION

Embodiments of the present invention are directed to various systems and methods for measuring grain on a dynamic platform. In one embodiment, the present invention is directed to a grain measuring system configured to be used with a grain harvesting device. The grain measuring system includes a weigh bucket and a cup assembly. The weigh bucket is configured to be positioned adjacent the grain harvesting device and includes an upper opening to receive grain from the grain harvesting device and a lower door configured to contain and release grain relative to the weigh bucket. The cup assembly is configured to be coupled to the weigh bucket and includes a sample cup configured to be positioned within the weigh bucket. In a first state, the sample cup and the weigh bucket are configured to simultaneously receive grain therein, the weigh bucket configured to provide a sample weight of the grain contained within both the weigh bucket and the sample cup. Further, in a second state, the lower door of the weigh bucket is open such that the grain left in the weigh bucket is contained in the sample cup, the sample cup being configured to be weighed to provide a sub-sample weight of the grain in the sample cup.

In another embodiment, the cup assembly is configured to calculate a grain test weight of the grain in the sample cup from the sub-sample weight of the grain and a volume of the sample cup. Further, the grain test weight calculated from the sub-sample weight is used to calculate a volumetric measurement based on the sample weight of the grain in the weigh bucket.

In another embodiment, the cup assembly includes a load cell coupled to the sample cup, the load cell configured to weigh the grain in the sample cup. Further, in another embodiment, the cup assembly includes a chamber positioned adjacent the sample cup and configured to protect the load cell, the load cell chamber configured to receive an air flow to purge the chamber of contaminates.

In still another embodiment, the sample cup includes a bottom door configured to empty grain from the sample cup to the lower door of the weigh container. The sample cup assembly also may include vibrator capabilities of the pneumatic assembly device configured to substantially uniformly settle the grain in the sample cup. For example, the sample cup assembly may further include a vibratory assembly. In another embodiment, the cup assembly includes a striker assembly, the striker assembly including a striking element configured to remove excess grain from the sample cup.

In another embodiment, the system further includes at least one moisture sensor configured to take a moisture measurement of the grain in the weigh bucket. Also, the system may include a pneumatic system coupled to the cup assembly. The system may also include a motion compensator device operatively coupled to the grain harvesting device. The motion compensator device is configured to sense conditions of at least one of slope and motion of the grain harvesting device to provide a weight adjustment to weight measurements obtained for at least one of the sample weight and sub-sample weight.

In another embodiment, the system includes a computing device having a processor and memory, the computing device operatively coupled to the grain harvesting device and configured to receive data relating to the grain being processed by the grain harvesting device. The computing device may include a portable computing field device.

In accordance with another embodiment of the present invention, a grain measuring system configured to be used with a weigh bucket coupled to a grain harvesting device is provided. The grain measuring system includes a grain test weight measuring apparatus having a sample cup. The grain test weight measuring apparatus is configured to be coupled to the weigh bucket and the sample cup is configured to be positioned within the weigh bucket. In a first state, the sample cup and a weigh bucket are configured to simultaneously receive grain therein to provide a sample weight of the grain contained within both the weigh bucket and the sample cup. In a second state, the sample cup is configured to provide a sub-sample weight of the grain, the sub-sample weight of the grain being weighed independently from the grain of the sample weight.

In accordance with another embodiment of the present invention, a method for harvesting and measuring grain is provided. The method includes: harvesting grain with a grain harvesting device; channeling the grain into a weigh bucket and a sample cup, the sample cup being smaller than the weigh bucket and the sample cup being positioned inside the weigh bucket, so that the grain fills the sample cup and fills a portion of the weigh bucket; determining a sample weight of the grain including the grain in both the weigh bucket and the sample cup; releasing the grain in the weigh bucket while maintaining grain in the sample cup; determining a sub-sample weight of the grain in the sample cup; calculating a test weight measurement of the grain in the sample cup based on the sub-sample weight of the grain in the sample cup and a volume of the sample cup; and calculating a volume of the grain in the weigh bucket based on the test weight measurement and the sample weight of the grain in the weigh bucket.

In another embodiment, the method for determining the sub-sample weight includes actuating a striker assembly to level any excess grain from the sample cup. In another embodiment, the determining may include vibrating the sample cup to substantially uniformly settle the grain in the sample cup. In still another embodiment, the determining may include compensating the sub-sample weight based on slope and dynamic motion of the grain harvesting device.

In another embodiment, the method further includes transmitting data to a user viewable device. In still another embodiment, the method further includes forcing air through a load cell chamber operatively coupled to the sample cup to substantially purge contaminates from the load cell chamber.

### BRIEF DESCRIPTION OF THE DRAWINGS

The foregoing and other advantages of the invention will become apparent upon reading the following detailed description and upon reference to the drawings in which:

FIG. 1 is a simplified view of a grain harvesting device, depicting a weigh bucket positioned beneath a hopper, according to another embodiment of the present invention;

FIG. 2 is a block diagram of a system to harvest and measure grain, according to an embodiment of the present invention;

FIG. 3 is a perspective view of a grain test weight measuring apparatus mounted to a weigh bucket, according to another embodiment of the present invention;

FIG. 4 is a perspective front view of a grain test weight measuring apparatus, according to another embodiment of the present invention;

FIG. 5 is perspective side view of a sample cup, load cell and a striker assembly with a portion of the housing removed, according to another embodiment of the present invention; and

FIG. 6 is a perspective rear view of the grain test weight measuring apparatus, depicting the pneumatic system and the control module, according to another embodiment of the invention.

### DESCRIPTION OF EXEMPLARY EMBODIMENTS OF THE INVENTION

Embodiments of the present invention relate to systems and methods for obtaining a grain test weight on a dynamic platform. A grain test weight measuring apparatus includes a sample cup, a striker assembly, a pneumatic assembly, a load cell assembly, and a control module. The grain test weight measuring device is configured to receive a sub-sample of grain in the sample cup and obtain measurements of the grain on a dynamic platform.

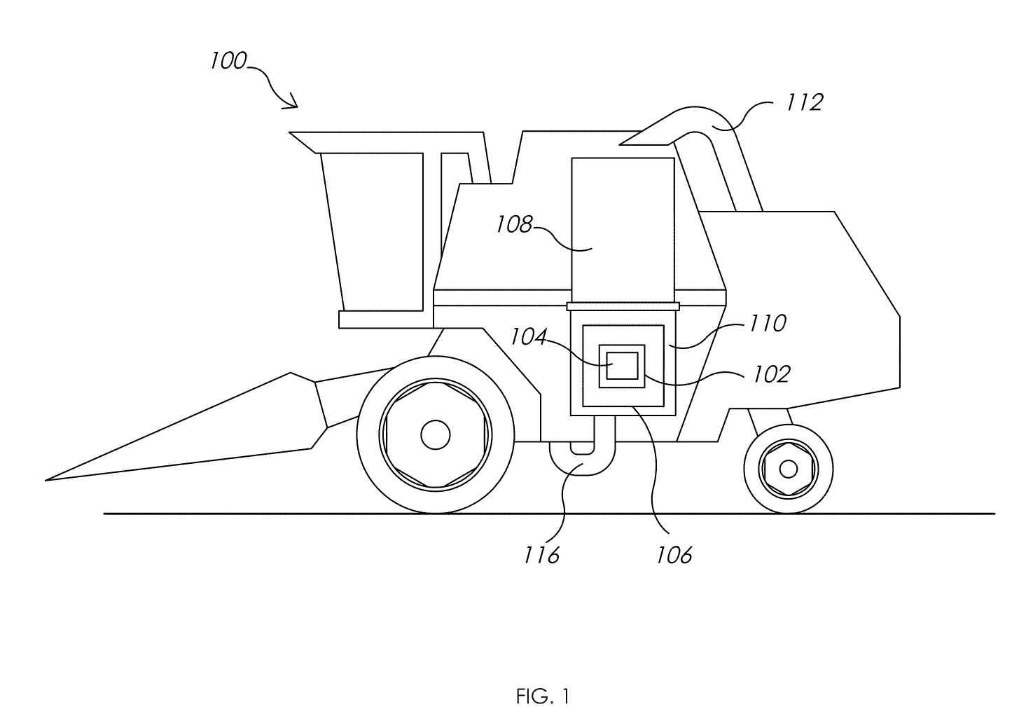

With attention now to FIG. 1, a system 100 for harvesting and measuring grain is shown. The system 100 may be employed for measuring all types of grain, such as, corn, wheat, barley, etc., or any other type of grain harvested with a grain harvesting device. In addition, the system 100 may be employed with any grain harvesting device or grain combine known in the art. Moreover, the system 100 provides a way to harvest grain and determine the volume of the grain “in stream” with the grain as the grain is channeled through the system 100.

As shown in FIG. 1, the invention includes a grain test weight measurement apparatus (“GTWMA”) 102 that includes a sample cup 104, the GTWMA 102 configured to be employed, in one embodiment of the invention, with a weigh bucket 106. The GTWMA 102 may also be referred to as, at least in part, a cup assembly. Such a GTWMA may be employed in or incorporated as an accessory to a grain harvesting device or the like. In another embodiment, the weigh bucket 106 and the GTWMA 102 may be positioned below or beneath a hopper 108 and within a grain weight and moisture measurement system (“GWMM system”) 110. The GWMM system 110 may be employed in conjunction with the present invention and is utilized to obtain plot data to obtain accurate and reliable measurements and grain traits for plots harvested. For example, one type of the GWMM system 110 is disclosed in detail in U.S. Pat. No. 5,487,702 to Campbell et al., assigned to Applicant, and incorporated herein in its entirety.

As noted above, the weigh bucket 106 and GTWMA 102 may be coupled to the harvesting system 100 and may be, in one embodiment of the invention, positioned in GWMM system 110. By utilizing the GTWMA 102 with the GWMM system 110, the harvester and/or researcher can maximize the information obtained relating to quality and quantity and other grain traits for a given plot harvested.

In operation, the process of obtaining data from a harvested grain sample, in simplistic form, begins with grain being cut and processed through the harvesting system 100 and channeled through a feed line 112 and subsequently dropping into a hopper 108. A gate is opened in the hopper 108 to allow an appropriate amount of grain to fill a portion of the weigh bucket 106 and all of the sample cup 104, which, in one embodiment of the invention, is positioned in the weigh bucket 106. The grain in the weigh bucket 106 may then be weighed to obtain a sample weight of such grain. It should be noted that the sample weight includes all the grain in the weigh bucket 106, including the grain in the sample cup 104.

The weigh bucket 106 is then emptied and the excess grain in the sample cup 104 is leveled, leaving only the grain in the sample cup 104 in the weigh bucket 106. A fixed volume of grain thus remains in the weight cup 104. The grain in the sample cup 104 is weighed as a load cell (not shown) supporting the sample cup 104 produces an electronic signal change proportional to the fixed column of the weight of grain in the weight cup 104.

Electronics incorporated into the GTWMA, as well as electronics incorporated into the GWMM, calculate the weight measurement, including incorporating technology to improve the accuracy of the measurement of the grain test weight such as anti-aliasing and slope and motion compensation from a co-located slope and motion sensor. The anti-aliasing, and slope and motion compensation, may be determined by devices, such as, for example, an anti-aliasing device and a slope and motion compensation device, respectively. The weight of the sample cup contents is then normalized and the resulting volume gives the test weight measurement of the sample contained in the sample cup 104.

Next, a bottom door, or other closeable opening, (not shown) of the sample cup 104 is actuated to empty the cup. The contents of the sample cup 104, and the previously discharged contents of the weight bucket 106, are discharged into chute 116. The door of the sample cup 104 is then shut, as is the door of the weigh bucket 106, and the sample cup 104 and weigh bucket 106 are ready to proceed with the next test measurement cycle—that is, the cycle of receiving grain in the weigh bucket 106 and sample cup 104 from the hopper 108, obtaining a plot weight of the grain contained within both the sample cup and the weigh bucket and obtaining other data for the grain sample, including moisture data, obtaining a grain test weight of the sub-sample of grain contained in the sample cup 104, and discharging the grain.

Thus, a system for quickly obtaining accurate measurements of grain test weight in-stream with a grain harvester, on a dynamic platform, is shown. The measurements obtained by the GTWMA 102, for example, the grain test weight measurement, can be determined in a time of less than one second. A grain test weight measurement of plots of grain are time critical; and being able to perform such measurements with great accuracy in such a short time period, namely, in less than one second, provides a significant improvement for harvesters and researchers. In addition to the apparatuses and functionalities outlined above, it is to be appreciated that in other embodiments of the invention additional functionality may be employed with or coupled to the GTWMA and/or GWMM system to ensure or enhance accurate and repeatable measurements of the sub-sample weight of the grain in the sample cup, or the grain test weight.

Having collected measurements from the grain sample contained within the GWMM system 110, as well as measurement of the sub-sample contained within the GTWMA 102, specifically in the sample cup 104, the test weight of the grain in the sample cup 104 may be calculated or determined. With this arrangement, the GTWMA 102 and weigh bucket 106 provide a way to obtain accurate weight, test weight, and moisture measurements from the plot in-stream with the grain as the grain is harvested on a dynamic platform.

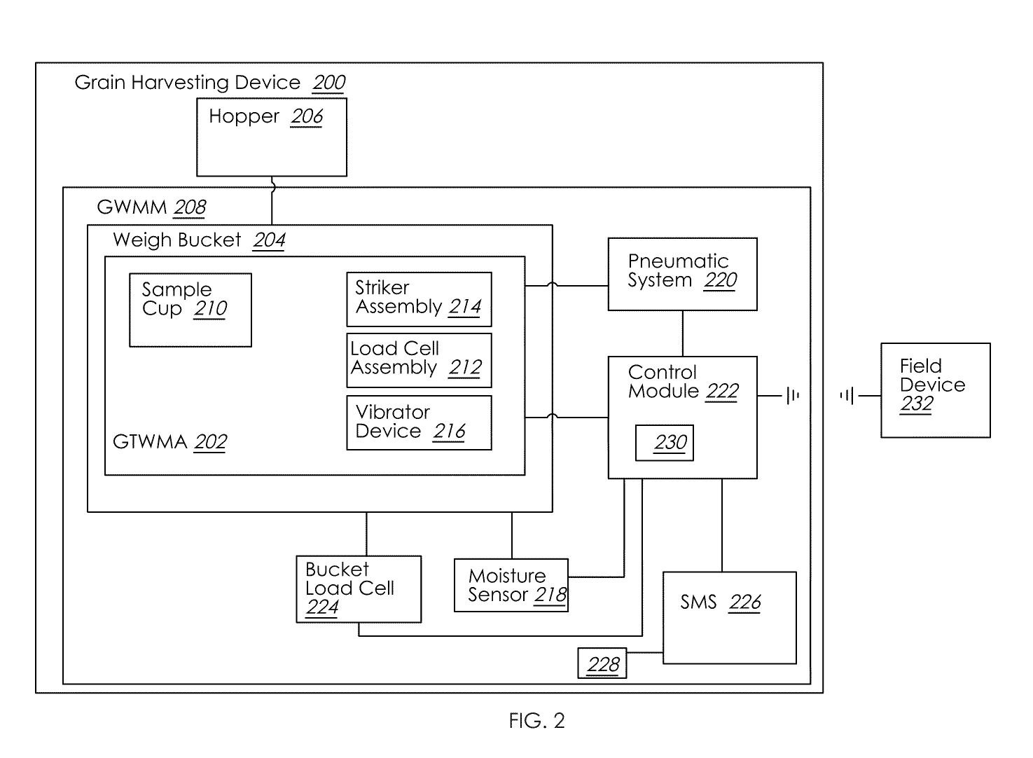

With reference now to FIG. 2, a block diagram depicting the a grain harvesting system or device 200, similar to harvesting system 100 shown in FIG. 1, with some of its various sub-assemblies and sub-systems is provided. In one embodiment of the invention, harvesting system 200 may include a GTWMA 202 employed with a weigh bucket 204 that may further be employed with a hopper 206 and contained within a GWMM system 208, each coupled to the harvesting device 200. In another embodiment, the GTWMA 202 may include a sample cup 210, a weight transducer assembly, such as, for example, load cell assembly 212, a striker assembly 214, a vibrator device 216, moisture sensors 218, a pneumatic system 220, and a control module 222.

In addition, weigh bucket 204 may include one or more weigh bucket load cells 224 configured to measure the grain in the weigh bucket 204, and thus obtain the sample weight, as previously discussed. Further, weigh bucket 204 may include one or more moisture sensors 218 configured to sense and determine a moisture measurement of grain in the weigh bucket 204. Moreover, weigh bucket 204, as well as GTWMA 202, may be coupled to a slope and motion sensor (“SMS”) sub-system 226 and anti-alias filtering system 228 to enhance measurement accuracy. Further details of SMS sub-system 226 and anti-alias filtering system 228 are disclosed in detail in U.S. Pat. No. 6,313,414 to Campbell, assigned to Applicant, and incorporated herein in its entirety.

In addition, control module 222 may include processors 230 and controls configured to activate and deactivate the above-noted components of the GTMA 202, as well as receive and store relevant data and transmit such data and calculations, via a signal processor, to a remote computer, such as a portable computing field device 232. In this manner, the operator of the grain harvesting device 200 can receive data from the GTWMA 202 and view, analyze, and store such data via the portable computing field device 232 while harvesting the grain.

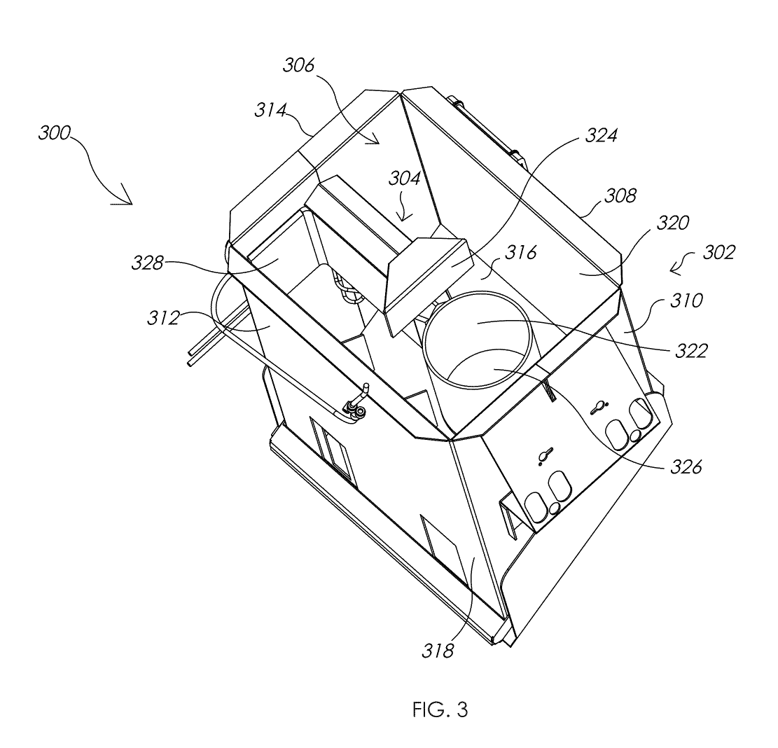

While FIG. 2 shows a block diagram of components incorporated within a grain harvesting device 200, FIG. 3 shows a weigh system 300, including weigh bucket 302 and GTWMA 304. In one embodiment of the invention, weigh bucket 302 may include a box-like configuration defining an open top 306. In particular, weigh bucket 302 may include a first wall 308, a second wall 310, a third wall 312, a fourth wall 314, and a door 316. Further, weigh bucket 302 includes an outer surface 318 and an inner surface 312, with various flanges, brackets and mounts attached to or extending therefrom. The first and third walls 308 and 312 may be on opposite sides of the box-like configuration oriented such that walls 310 and 312 are parallel.

Likewise, the second and fourth walls 310 and 314, may be on opposite each other and configured such that walls 310 and 314 are parallel. Each of the walls of weigh bucket 302 extends to door 316 that is angled downward between the first wall 308 and the third wall 312. As such, the first wall 308 may include a smaller height dimension than the third wall 312. Moreover, the angled door 316 may provide structure to facilitate grain to funnel-out of weigh bucket 302 as desired when door 316 is opened. In addition, weigh bucket 302 may include a bucket load cell (not shown) coupled to weigh bucket 302 and sized and configured to take the sample weight of the grain contained in weigh bucket 302. Further, weigh bucket 302 may include other sensors, such as a moisture sensor (as shown in FIG. 2), for taking various measurements of the grain contained in weigh bucket 302.

GTWMA 304 includes a sample cup 322, located near striker 324, and having a bottom door 326. In other embodiments of the invention not shown in FIG. 3, sample cup 322 may include other closeable opening through which gain contained within sample cup 322 may be emptied. As noted above, striker 324, which levels grain contained within sample cup 322 to ensure a specific volume of grain is contained within sample cup 322 for test measurements, is located near sample cup 322.

Finally, GTWMA 304 may be mounted or coupled to weigh bucket 302 with at least a portion of GTWMA 304 positioned within weigh bucket 302. In particular, various plates may be used to secure the GTWMA 304 to weigh bucket 302, such as, for example, mounting plate 328. As shown in FIG. 3, mounting plate 328 secures GTWMA 304 to weigh bucket 302 at wall 314.

While GTWMA 304 may be mounted within or coupled to weight bucket 302, GTWMA 304 In operation, when a grain harvesting system or device is in use, such as those shown in FIGS. 1 and 2, grain from a hopper (not shown) is dispensed into weigh bucket 302. When the grain initially enters weigh bucket 302, door 316 is closed such that the grain is contained within the weight bucket 302 by door 316 and walls 308, 310, 312, and 314 of weigh bucket 302. As grain enters weigh bucket 302 from one or more hoppers, grain also fills sample cup 322 of GTWMA 304. This sample of grain from a plot is measured for weight and moisture content. Door 316 then opens, thus discharging all the grain contained in weigh bucket 302 except for the sub-sample of grain that remains in sample cup 322. Striker 324 of GTWMA 304 levels the grain in sample cup 322 leaving a fixed volume in sample cup 322 to be weighed. The sub-sample of grain in sample cup 322 is measured, and the bottom door 326 of sample cup 322 is actuated to empty the cup, and then closes to ready the cup to receive the next sample of grain. Finally, door 316 of weigh bucket 302 closes and the weigh system 300 is ready to receive a new sample of grain. Thus, weigh system 300 is able to quickly and accurately provide a test weight measurement of grain in-stream on a dynamic platform.

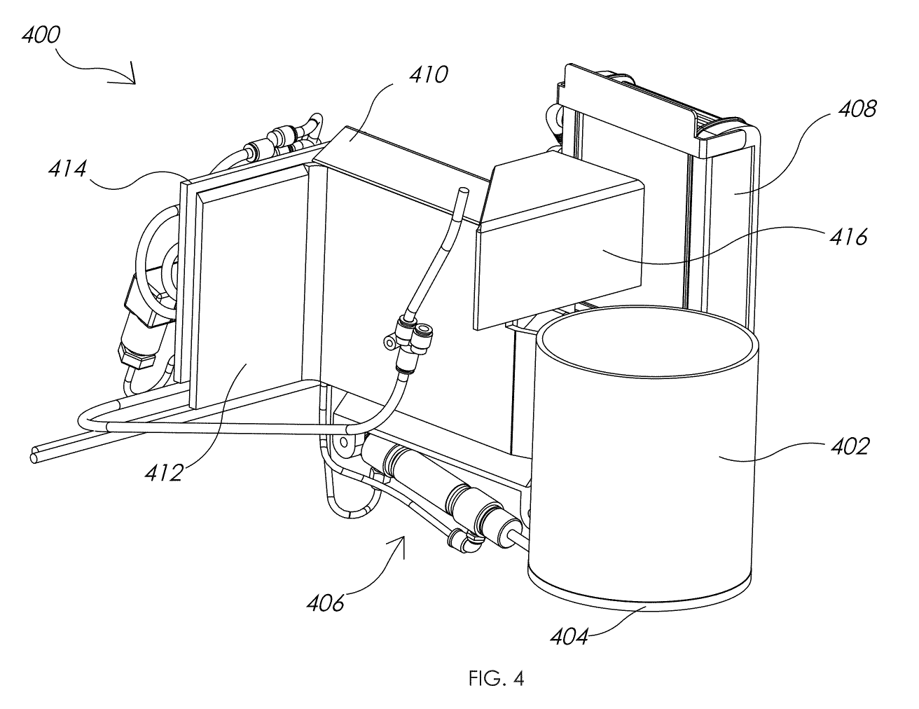

Directing attention now to FIG. 4, a GTWMA 400 is shown. GTWMA 400 includes sample cup 402, which further includes bottom door 404, pneumatic actuators 406, control module 408, which may further include SMS, moisture content measuring, and anti-aliasing sub-assemblies, as noted above. GTWMA 400 further includes housing 410, mounting brackets 412 and 414. In one embodiment of the invention, GTWMA 400 is secured within a weigh bucket (not shown) when mounting bracket 412 is placed against an inside surface of a wall of a weigh bucket and fastened to mounting bracket 414, which is placed against an outside surface of a wall of a weigh bucket. Fasteners (not shown) secure mounting bracket 412 to mounting bracket 414, and thus secure GTWMA 400 to a weigh bucket apparatus. Finally, GTWMA 400 also includes striker assembly 416, having actuating mechanisms (not shown) housed in housing 410.

Bottom door 404 of sample cup 402 is operable connected to pneumatic actuators 406, which are mounted beneath housing 410. In addition to holding and releasing grain in sample cp 402, door 404 and pneumatic actuators 406, in combination with electrical components not shown in FIG. 4, comprise a vibratory assembly configured to vibrate the contents of the sample cup 402 and settle the grain sub-sample contained therein to further ensure a that the test weight measurement is procured from a uniform and specific volume of grain contained within sample cup 402.

In operation, GTWMA 400 is configured to produce a grain test weight measurement for a plant breeder or other scientist or researcher when a sample of a plot's grain is deposited within a weigh bucket (not shown in FIG. 4) within which GTWMA 400 is mounted. After the weight and moisture content of the grain within the weigh bucket are determined, grain within the weigh bucket, except that contained in sample cup 402, is discharged. Striker assembly 416 is then actuated to level the grain contained in sample cup 402. Pneumatic actuators 406 produce vibrations which function to settle the contents of sample cup 402, thus ensuring a precise volume of grain is contained within sample cup 402 for each set of measurements taken. The fixed volume of grain in sample cup 402 is measured as a load cell (not shown) supporting sample cup 402 produces an electronic signal change proportional to the fixed volume of the weight of the grain in the sample cup 402. In one embodiment of the invention, the sample weight is determined electronically as other measurements of the grain, including anti-aliasing and motion compensation measurements, are determined. After the measurements of the sub-sample of grain contained with sample cup 402 have been completed, pneumatic actuators 406 open bottom door 404, thus releasing the grain from sample cup 402. The bottom door 404 then closes and the sample cup 402 is ready to receive another sub-sample of grain and repeat the measurement process, which quickly provides in-stream measurements of grain test weight on a dynamic platform with a high degree of accuracy.

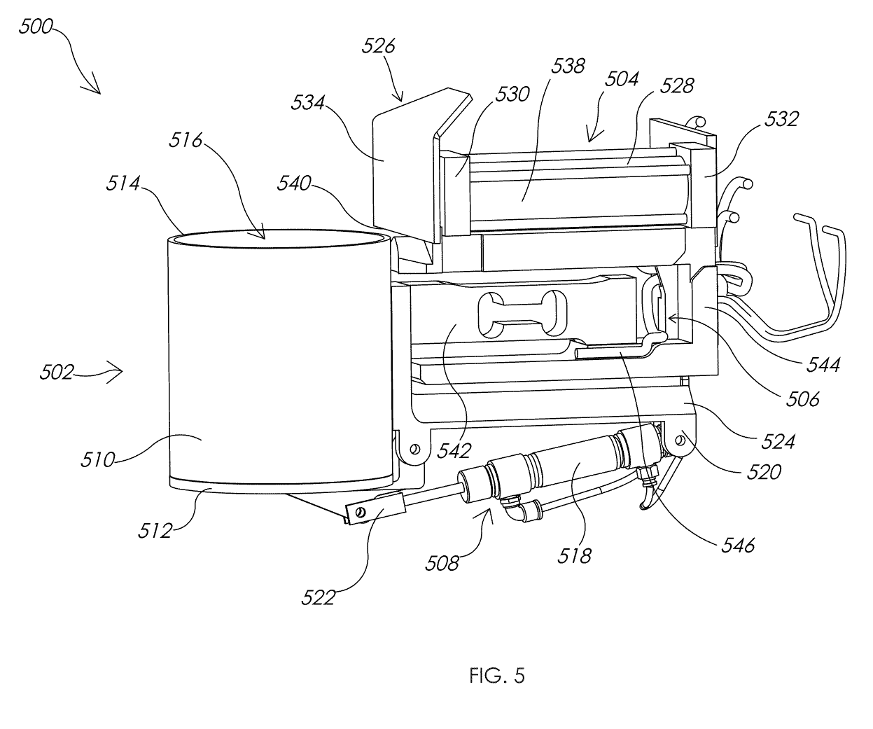

With attention now to FIG. 5, embodiments of a GTWMA 500 are shown in greater detail. To begin, in one embodiment of the invention, GTWMA 500 includes sample cup 502, striker assembly 504, a weight transducer assembly, such as, for example, a load cell assembly 506, pneumatic assembly 508, and a control module (not shown). GTWMA 500 may use these and other sub-systems in addition to those identified above in determining an accurate grain test weight measurement. While this measurement is known to persons in the industrial and/or research environments of seed trade and commercial grain sales as “grain test weight,” such a measurement may also accurately be referred to as a “bulk density” measurement.

As previously set forth, the GTWMA 500 is configured to test the weight of grain volumetrically to obtain grain test weight measurements, in a controlled and isolated environment, in stream with the grain being harvested. In other words, the GTWMA 500, with its various sub-systems, can obtain weight values of the grain within a defined volume to, thereby, obtain a test weight value for the grain. Such test weight measurements obtained by the GTWMA 500 are obtained in-stream as a sub-sample of the grain in a weigh bucket. The GTWMA 500 is a many-faceted apparatus that can include multiple and varied systems and sub-systems configured to take accurate and precise measurements with respect to grain samples and sub-samples. Embodiments of several such systems and sub-systems are set forth in detail below.

In one embodiment of the invention as shown in FIG. 5, GTWMA 500 includes sample cup 502. Sample cup 502 may be positioned within a weigh bucket, as shown previously with reference to FIG. 3. In addition, sample cup 502 may be sized and configured to be filled with grain and weighed to obtain a sub-sample weight of the grain. In one embodiment of the invention, sample cup 502 includes a cylindrical type shape, or any other shape suitable for containing grain. Moreover, sample cup 502 may include a tubular wall 510 that extends from a bottom door 512 to an upper edge 514, which defines an opening 516 configured to receive grain.

While opening 516 is configured to receive grain and tubular wall 510 is configured to contain grain in conjunction with bottom door 512, bottom door 512 is further configured to be movable between a closed position and an open position via pneumatic assembly 508. It is to be appreciated, however, that other non-pneumatic mechanical or electrical systems could be employed to open a door or lid of sample cup 502. In short, any system that works to release a volume of grain from sample cup 502, or to empty sample cup 502 of grain, is included in embodiments of the present invention. In one embodiment of the invention, pneumatic assembly 508 may include pneumatically actuated cylinder 518, a first hinge bracket 520, and a second hinge bracket 522. Pneumatically actuated cylinder 518 may be positioned below load cell assembly 506 and mounted between the first and second hinge brackets 520 and 522, secured to the cup mount bar 524 and the bottom door 512, respectively. In this manner, pneumatic assembly 518 may be actuated between the open and closed positions with the pneumatically actuated cylinder 518.

As noted above with reference to FIG. 3, the GTWMA 500 may include a striker assembly 504 and a load cell assembly 506. In one embodiment, striker assembly 504 may be positioned directly above load cell assembly 506. While a housing is shown in FIG. 4, FIG. 5 shows striker assembly 504 and load cell assembly 506 with the housing removed, thus provided a more detailed view of striker assembly 504 and load cell assembly 506, and thus illustrating some of the structural components of striker assembly 504 and load cell assembly 506.

Striker assembly 504 functions to level the contents of sample cup 502 and embodiments of the striker assembly 504 of the present invention include any system capable of leveling the contents of the sample cup. Striker assembly 504 is configured to be a fast, simple, and robust apparatus for leveling the grain in the sample cup 502. In one embodiment of the invention, as shown in FIG. 5, striker assembly 504 includes strike plate 526, striker actuating cylinder 528, and first striker bracket 530 and second striker bracket 532. Strike plate 526 includes strike face 534 with an upper portion that may extend at an angle from the strike face 534. Such a strike plate 534 may be positioned adjacent and above the sample cup 502 and is configured to move in a retracted position (as depicted) and an extended position. Striker assembly 504 may include a pneumatic linear actuator, such as, for example, striker actuating cylinder 528, which is positioned between first striker bracket 530 and second striker bracket 532.

In addition, striker actuating cylinder 528 may further include a twin rod cylinder 536. First striker bracket 530 may include one or more bores or openings to facilitate interconnection of the twin rod cylinder 538 to the striker plate 526. Moreover, striker actuating cylinder 528 may include one or more pneumatic connections to actuate such cylinder to move between the refracted position and the extended position. With this arrangement, striker assembly 504 pneumatically actuates striker actuating cylinder 528 to the extended position such that the strike plate 526 is configured to move forward with a bottom edge 540 of strike plate 526 substantially flush with upper edge 514 of sample cup 502 to level the grain in sample cup 502.

Once moved forward, the striker assembly 504 can be pneumatically actuated such that the strike plate 526 moves back to the refracted position. It is to be appreciated that, in other embodiments of the invention, striker assembly 504 may include other mechanical and/or electrical systems, which may or may not include pneumatic devices, to level the grain of the sample cup 502. Striker assembly 504 functions to make sure that the contents of the sample cup 502 are of a specific volume. The contents of the sample cup 502 are therefore leveled to ensure a consistent and specific grain volume in the sample cup 502.

As noted above, load cell assembly 506 may be positioned below striker assembly 504 and adjacent sample cup 502. Load cell assembly 506 is configured to weigh the grain in sample cup 502. As shown in FIG. 4, load cell assembly 506 is housed, at least in part, by mounting bracket 412 and housing 410. Such housing defines, at least in part, a load cell chamber shown in the cut-away view of FIG. 5. The load cell chamber is a substantially closed chamber, and all air flow within the chamber occurs in one direction. In addition to the load cell chamber, load cell assembly 506 may include, among other things, load cell 542 and load cell mounting bracket 544, load cell 542 being positioned with and secured by load cell mounting bracket 544.

Although load cell 542 is housed and protected by the mounting bracket 412 and housing 410 shown in FIG. 4, contaminates are able to collect within the load cell chamber that surrounds load cell 542, due to the inherent nature of weighing grain in-stream with the harvesting process. Over time, such contaminates and debris may cause inaccurate measurements and otherwise inhibit the function of load cell 542. Thus, in one embodiment of the invention, load cell assembly 506 includes exhaust hose 546 positioned adjacent load cell 542 and within the load cell chamber (defined by mounting bracket 412 and housing 410, and other as shown in FIG. 4, as well as other structure, such as, for example, load cell mounting bracket 544). Such exhaust hose 546 provides air, such as, for example, exhausted air from the pneumatic operations of GTWMA 500, to purge the load cell chamber of foreign contaminates or debris. In this manner, GTWMA 500 provides an isolated and independent load cell 542 within a weigh bucket (not shown) for weighing an independent portion of grain within such weigh bucket. Further, load cell 542 is self maintained and self cleaned of contaminates and debris with purging air flow from the pneumatic systems, such as pneumatic assembly 508, of GTWMA 500.

In operation, GTWMA 500 receives grain as grain enters opening 516 of sample cup 502. Pneumatic assembly 508 is configured to vibrate the contents of sample cup 502, thus settling the contents within sample cup 502 and ensuring consistent grain volume within the cup from test to test. Striker assembly 504 then moves from a retracted to an extended position as striker actuating cylinder 528 forces striker plate 526 away from first striker bracket 530. Bottom edge 540 of strike plate 526 thus scrapes along upper edge 514 of sample cup 502, thus leveling off the surface of the grain sub-sample within the sample cup 502 and leaving a fixed volume to be weighed.

Next, load cell assembly 506, with load cell 542 supporting sample cup 502, produces an electronic signal change proportional to the fixed volume of the weight of the grain sub-sample contained in sample cup 502. Electrical components (not shown) of load cell 542 determine the weight measurement of sample cup 502, and further include other measuring functionality, such as anti-aliasing and slope and motion compensation from a co-located slope and motion sensor. After the measurements have been taken, the grain contained in sample cup 502 is discharged as bottom door 512 is opened by pneumatic assembly 508. Bottom door 512 is subsequently close by pneumatic assembly 508, and exhaust air from pneumatic assembly 508 is routed to exhaust hose 546 within load cell assembly 506. Air from exhaust hose 546 purges load cell assembly 506 from contaminates, keeping load cell assembly clean and ensuring accuracy of measurements. GTWMA 500 is then ready to receive a new grain sample and to take a new set of measurements. Moreover, GTWMA 500 is able to provide accurate measurements of grain test weight in-stream on a dynamic platform, all in less than one second.

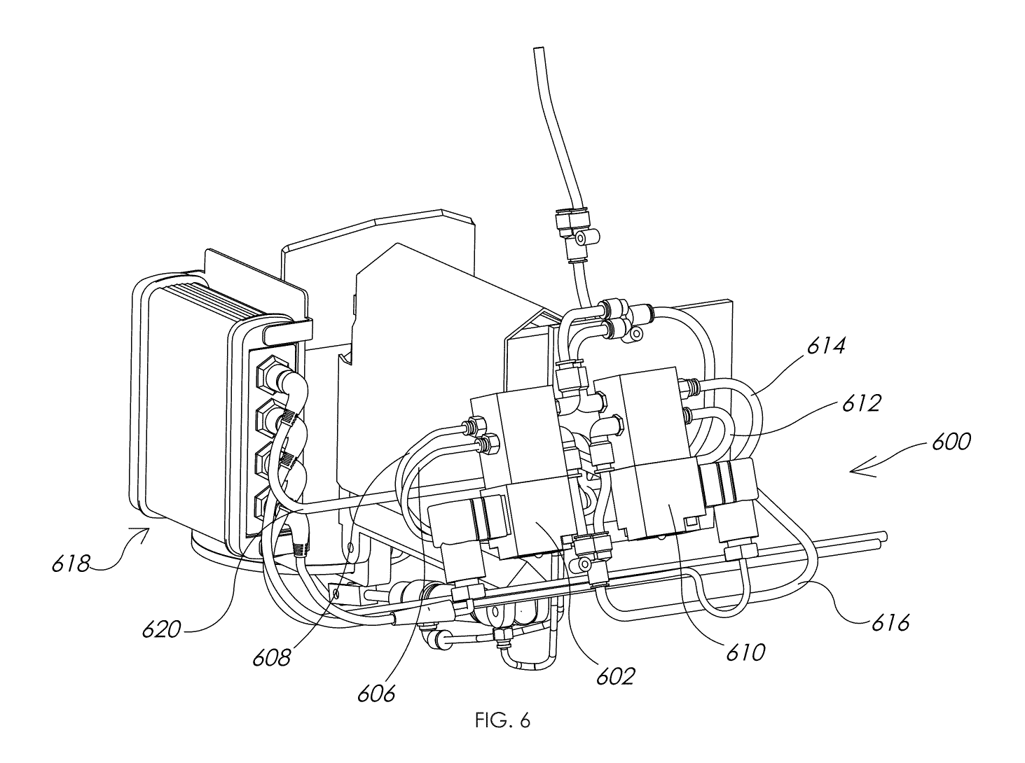

Referring now to FIG. 6, as previously indicated, the GTWMA may include a pneumatic system 600, as shown. The pneumatic system 600 may be mounted adjacent or against the outer surface of a wall of a weigh bucket, such as, for example, the outer surface of fourth wall 314 of weigh bucket 302, as shown in FIG. 3. The pneumatic system 600 may include one or more actuator valves, such as a first actuator valve 602 and a second actuator valve 604, with various air hoses extending to the various actuating components of GTWMA. For example, the first actuator valve 602 may include a bottom door-open hose 606 and a lid-close hose 608, each respectively configured to funnel and force air to pneumatically actuate the pneumatic cylinder 518 to move the bottom door 512, as shown in FIG. 5, between the open position and the closed position. Similarly, the second actuator valve 610 may include a striker-retract hose 612 and a striker-extend hose 614, each configured respectively to actuate the striker assembly 504 between an extended position and a retracted position, as set forth above with reference to FIG. 5. Further, the pneumatic system 600 includes a main line hose 616 configured to receive air pressure from an air source, such as, for example, a compressor (not shown).

As noted above, in some embodiments of the invention, the GTWMA includes a control module, such as control module 618, shown in FIG. 6. Control module 618 may be mounted to a weigh bucket, as shown in FIGS. 2 and 3. Control module 618 may include one or more processors (not shown) configured to control the functionality of the GTWMA. Further, the processors of control module 618 can receive data and transmit such data to a remote computing device, such as a portable computing field device (not shown). In one embodiment of the invention, control module 618 includes numerous cables extending from control module 618 to the various sub-systems/assemblies of the GTWMA. For example, the control module 618 can include an actuator cable 620 extending from control module 618 to the first and second actuator valves 602 and 610. From this configuration, a processor can control and activate the actuation valves and, thereby, control movement components as shown in FIG. 5, such as, for example, movement of strike plate 534 of striker assembly 526, and movement of the bottom door 512 of sample cup 502 based on the programming therein, as known to one of ordinary skill in the art. Similarly, control module 618 may include other cables, such as a load cell cable, extending from the control module 618 to receive, process, and transmit measurements taken by a load cell, such as load cell 542 shown in FIG. 5. Other cables may include a power cable or other cables for transmitting measurement data to control module 618. Control module 618 can also include a signal processor, as previously indicated, for transmitting data and calculations from the GTWMA to the remote computing device, and vice versa.

Stated differently, in one embodiment of the invention GTWMA 500 is employed with a grain harvesting device. As grain is cut and processed through the grain harvesting device, the grain may be channeled to one or more hoppers (as shown in FIGS. 1 and 2). Once a full level is detected, the hopper door may open to dump an adequate grain sample to a weigh bucket (as shown in FIGS. 1-3) with a closed weigh bucket door. The grain fills a portion of the weigh bucket and sample cup 502 of GTWMA 500, mounted inside the weigh bucket. The hopper door may then close. The sample of grain in the weigh bucket then settles and moisture measurements of the grain may be taken with a moisture sensor (not shown). The sample of grain in the weigh bucket may then be weighed to obtain a sample weight. With the SMS sub-system (not shown), SMS data may be sampled and used to calculate a compensation factor for the sample weight based on dynamics/vibrations and slope of the platform or grain harvesting device. The weigh bucket may then be dumped via gravity by opening the lower door of the weigh bucket. As such, all grain in the weigh bucket exits, except for the sub-sample of grain contained in the sample cup 502.

Next, pneumatic system 508 may vibrate to settle the grain in the sample cup 502 for substantial consistency therein. Striker assembly 504 may then be activated such that strike plate 526 is moved to an extended position to level the grain relative to the upper edge 514 of the sample cup 502 to further maintain substantial consistency with the volume of the sample cup 502 and for consistency between the subsequent repeatable uses of GTWMA 500. At this stage, exhausted air from operations of the pneumatic assembly 508 may be vented in the load cell chamber adjacent load cell 542 to purge the chamber of any foreign contaminates and debris. The sub-sample of grain in the sample cup 502 may then be weighed by the load cell 542 to obtain a sub-sample weight. Again, via the SMS sub-system, SMS data may be sampled and used to calculate a compensation factor for the sub-sample weight taken based on dynamics and slope of the grain harvesting device. Calculations can then be made with the processor to calculate the test weight of the sub-sample of grain based on the sub-sample weight and the known volume of the sample cup 502. Further calculations can be made with such test weight calculation to determine the volume of grain previously in the weigh bucket based on the sample weight of such grain. These calculations may be transmitted to a user viewable device, such as the portable computing field device. The bottom door 512 of the sample cup 502 may be opened to allow the grain of the sub-sample to exit the sample cup 502. The bottom door 512 of the sample cup 502 may then be closed. The cycle then repeats.

Based on the foregoing, the GTWMA provides information to a user relating to, among other things, test weight of grain being harvested as well as yield of the grain being harvested. Further, detailed information over specific areas or plots can be calculated and learned from the GTWMA relating to test weight values and changes in test weight values, which can be compared with regions of land that such values were obtained. Furthermore, the GTWMA, according to one embodiment, obtains measurements within a contained and controlled environment, in stream, with the grain being harvested.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A grain measuring system configured to be used with a grain harvesting device, the grain measuring system comprising:
a weigh bucket configured to be positioned adjacent the grain harvesting device, the weigh bucket including an upper opening to receive grain from the grain harvesting device and a lower door configured to contain and release grain relative to the weigh bucket; and
a sample cup assembly configured to be coupled to the weigh bucket, the sample cup assembly including a sample cup positioned within the weigh bucket;
wherein, in a first state, the sample cup and the weigh bucket are configured to simultaneously receive grain therein, the weigh bucket configured to provide a sample weight of the grain contained within both the weigh bucket and the sample cup; and
wherein, in a second state, the lower door of the weigh bucket is open such that the grain left in the grain measuring system is contained in the sample cup, the sample cup being configured to be weighed to provide a test weight of the grain in-stream as the grain is harvested from the grain harvesting device, on a dynamic platform.

2. The system of claim 1, wherein the sample cup assembly is configured to calculate a test weight of the grain in the sample cup from the sub-sample weight of the grain and a volume of the sample cup.

3. The system of claim 2, wherein the test weight calculated from the sub-sample weight is used to calculate a volumetric measurement based on the sample weight of the grain in the weigh container.

4. The system of claim 1, wherein the cup assembly comprises a load cell coupled to the sample cup, the load cell configured to weigh the grain in the sample cup.

5. The system of claim 4, wherein the cup assembly comprises a load cell chamber positioned adjacent the sample cup and configured to substantially surround the load cell, the load cell chamber configured to receive an air flow to purge the load cell chamber of contaminates.

6. The system of claim 4, wherein the air flow received in the load cell chamber to purge the load cell chamber of contaminates comprises an exhaust hose configured to deliver an air flow from exhaust air of a pneumatic assembly.

7. The system of claim 1, wherein the sample cup comprises a closeable opening configured to empty grain from the sample cup.

8. The system of claim 7, wherein the closeable opening is a bottom door of the sample cup.

9. The system of claim 7, wherein the closeable opening of the sample cup is opened and closed by a pneumatic actuator.

10. The system of claim 9, wherein the closeable opening of the sample cup and the pneumatic actuator further comprise a vibratory assembly configured to substantially settle grain in the sample cup.

11. The system of claim 1, wherein the sample cup assembly comprises a striker assembly, the striker assembly including a striking element configured to remove excess grain from the sample cup and level the sample cup.

12. The system of claim 11, wherein the striker assembly is actuated by a pneumatic linear actuator.

13. The system of claim 1, further comprising at least one moisture sensor configured to take a moisture measurement of one or more of: grain in the weigh bucket; and, grain in the sample cup.

14. The system of claim 1, further comprising a motion compensator device operatively coupled to the grain harvesting device, the motion compensator device configured to sense conditions of at least one of slope and motion of the grain harvesting device to provide a weight adjustment to weight measurements obtained for at least one of the sample weight and test weight.

15. The system of claim 14, further comprising a device configured to apply anti-aliasing filtering.

16. The system of claim 1, further comprising a computing device including a processor and memory, the computing device operatively coupled to the grain harvesting device and configured to receive data relating to the grain being processed by the grain harvesting device.

17. The system of claim 16, wherein the computing device comprises a portable computing field device.

18. A grain harvesting and measuring system, comprising:
a grain harvesting device;
a weigh bucket configured to be positioned adjacent the grain harvesting device, the weigh bucket including an upper opening to receive grain from the grain harvesting device and a lower door configured to contain and release grain relative to the weigh bucket; and
a cup assembly configured to be coupled to the weigh bucket, the cup assembly including a sample cup positioned within the weigh bucket;
wherein, in a first state, the sample cup and the weigh bucket are configured to simultaneously receive grain therein, the weigh bucket configured to provide a sample weight of the grain contained within both the weigh bucket and the sample cup; and
wherein, in a second state, the lower door of the weigh bucket is open such that the grain left in the weigh bucket is contained in the sample cup, the sample cup being configured to be weighed to provide a test weight of the grain in the sample cup in-stream as grain is harvested from the grain harvesting device, on a dynamic platform.

19. The system of claim 18, wherein the cup assembly is configured to calculate a test weight of the grain in the sample cup from the sub-sample weight of the grain and a volume of the sample cup.

20. The system of claim 19, wherein the test weight calculated from the sub-sample weight is used to calculate a volumetric measurement based on the sample weight of the grain in the weigh container.

21. The system of claim 1, wherein the cup assembly comprises a load cell coupled to the sample cup, the load cell configured to weigh the grain in the sample cup.

22. The system of claim 21, wherein the cup assembly comprises a chamber positioned adjacent the sample cup and configured to substantially surround the load cell, the load cell chamber configured to permit air flow in a single direction and to receive an air flow to purge the load cell chamber of contaminates.

23. A grain measuring system configured to be used with a weigh bucket coupled to a grain harvesting device, the weigh bucket including a lower door configured to contain and release grain relative to the weigh bucket, the grain measuring system comprising:
a GTWMA including a sample cup, the GTWMA configured to be coupled to the weigh bucket and the sample cup configured to be positioned within the weigh bucket,
wherein, in a first state, the sample cup and the weigh bucket are configured to simultaneously receive grain therein to provide a sample weight of the grain contained within both the weigh bucket and the sample cup; and
wherein, in a second state, the sample cup is configured to provide a sub-sample weight of the grain, the sub-sample weight of the grain being weighed independently from the grain of the sample weight.

24. A method for harvesting and measuring grain, the method comprising:
harvesting grain with a grain harvesting device;
channeling the grain into a weigh bucket and a sample cup, the sample cup being smaller than the weigh bucket and the sample cup being positioned inside the weigh bucket, so that the grain fills the sample cup and fills a portion of the weigh bucket;
determining a sample weight of the grain including the grain in both the weigh bucket and the sample cup;
releasing the grain in the weigh bucket while maintaining grain in the sample cup;
determining a sub-sample weight of the grain in the sample cup;
calculating a test weight measurement of the grain in the sample cup based on the sub-sample weight of the grain in the sample cup and a volume of the sample cup; and
calculating a volume of the grain in the weigh bucket based on the test weight measurement and the sample weight of the grain in the weigh bucket.

25. The method according to claim 24, wherein the determining the sub-sample weight comprises actuating a striker assembly to level any excess grain from the sample cup.

26. The method according to claim 24, wherein the determining the sub-sample weight comprises vibrating the sample cup to substantially uniformly settle the grain in the sample cup.

27. The method according to claim 24, wherein the determining the sub-sample weight comprises compensating the sub-sample weight based on slope and dynamic motion of the grain harvesting device.

28. The method according to claim 24, further comprising transmitting data to a user viewable device.

29. The method according to claim 24, further comprising forcing air through a load cell chamber operatively coupled to the sample cup to substantially purge contaminates from the load cell chamber.
